(19) United States
(12) Patent Application Publication
(10) Pub. No.: US 2020/0106793 A1
(43) Pub. Date: Apr. 2, 2020

(54) METHODS, SYSTEMS, AND COMPUTER PROGRAM PRODUCTS FOR CONTINUOUS CYBER RISK MONITORING

(71) Applicant: Olympus Infotech, LLC, Charlotte, NC (US)

(72) Inventor: Srinivasan Vanamali, Charlotte, NC (US)

(21) Appl. No.: 16/553,386

(22) Filed: Aug. 28, 2019

Related U.S. Application Data
(60) Provisional application No. 62/739,892, filed on Oct. 2, 2018.

(51) Int. Cl. H04L 29/06; G06F 9/451

(52) U.S. Cl. CPC H04L 63/1425; H04L 63/20; G06F 9/451; H04L 63/1416; H04L 63/1433

(57) ABSTRACT

The subject matter described herein includes methods, systems, and computer program products for a software as a service (SaaS) system for continuous cyber risk management and monitoring. The method includes storing, maintaining, and updating one or more rules that associates a cyber risk, threat, or vulnerability with an action for one or more assets. The one or more assets includes at least one of: information systems, critical infrastructure, tangible objects, persons, data, and metadata. When an event is detected, it is determined whether a rule applies to the event by searching and matching information associated with the event with the one or more rules. If a rule applies, an action may be performed and various users notified. The action performed includes a corrective, remedial, or mitigating action as specified by the applicable rule. The method for continuous cyber risk management and monitoring described herein are performed automatically and continuously.

### CROSS-REFERENCE TO RELATED APPLICATION

This application claims the benefit of priority of U.S. Provisional Patent Application No. 62/739,892, titled “CONTINUOUS CYBERRISK MONITORING” filed on Oct. 2, 2018 which is incorporated herein in its entirety by this reference.

### BACKGROUND

### Field of the Invention

The present invention relates to cyber risk monitoring, and more specifically, to software as a service (SaaS) for providing continuous monitoring, notification, and updating of cyber risks associated with assets under management.

### Description of Related Art

The International Organization for Standardization (ISO) defines risk as the “effect of uncertainty on objectives.” Generally, risk is a measure of the likelihood of a threat materializing combined with the consequences of that threat compromising the asset. This measure of risk may be expressed in qualitative terms, including a user-defined scale such as low, medium, or high, or in quantitative terms, which may be actionable by a computer program or person. Thus, risk represents exposure to harm or loss expressed as a combination of potential impact, likelihood, and control effectiveness. It should also be noted that risk may be subject to change as the risk environment changes and is not static.

Risk management is the ongoing process of identifying, assessing, and responding to risk. To manage risk, organizations should assess the risk and then determine the best approach to deal with the risks: avoid, transfer, accept, or mitigate.

More specifically, “cyber” risk includes any risk of financial loss, disruption, or damage to the reputation of an organization from a failure of its information technology systems. Some examples of cyber risks include human error, hackers, spear phishing, extortion, and hacktivists. Human error cyber risk may include lost or stolen laptops and smartphones. These devices may be used to access an unsecured database containing large amounts of private information. Hacker cyber risk may include attacking a retailer's point of sale system to obtain customer financial information. Spear phishing cyber risk may include social engineering targeted at employees, such as a trojan horse email triggering a computer virus that allows unauthorized users to disable security measures or taking control of financial accounts. Extortion cyber risk may include a rogue employee gaining access to a company's data system through an SQL injection attack and attempting to extort money in exchange for restoring important data. Hacktivist cyber risk may include a company using weak encryption to secure their customer database which is exposed by hacktivists in order to publicize the importance of stronger encryption.

Organizations currently spend millions of dollars per year on control measures to protect assets. However, these organizations are still exposed to various cyber risks and are often unable to sufficiently measure any residual risk factor and apply an appropriate risk treatment plan as part of overall cybersecurity risk management strategy. This is because they do not use holistic and continuous cyber risk management strategies.

To combat cyber threats and vulnerabilities, two conventional technologies exist. A first cyber risk management technology includes systems and methods which integrate threat management and vulnerability management systems. The second category of cyber risk management includes risk management systems that provide a point in time analysis, or a periodic or ad hoc review of cyber risks. Each of these systems is limited because they fail to broadly define cyber risk in a holistic manner that includes people, process, and technologies. Moreover, these systems often fail to provide proactive monitoring and identification of emerging cyber risks on a continuous and automated basis.

For example, a common approach that organizations take to address these challenges is to implement a set of baseline controls. This control-driven approach is often applied as a multi-layered security model that features perimeter security, vulnerability scanners, intrusion detection systems, etc. This control-driven approach, however, has a significant flaw because conventional models do not establish an asset-specific risk profile. Without establishing an appropriate risk profile, sufficient controls cannot be implemented, and residual risks cannot be evaluated.

Conventional configurations that perform risk assessment at a point in time based on known threats and vulnerabilities leave critical systems and assets exposed without appropriate controls and sufficient risk treatment plan for a changing risk profile of an asset due to emerging threats and vulnerabilities from known and unknown sources. For example, limitations of conventional risk management solutions include limited tools, threat identification is not based on standards, risk assessment is not comprehensive, a lack of continuous monitoring of emerging threats, and are expensive. Often, basic form-based tools with limited functionality from a collaboration perspective are used in conventional risk management solutions. Similarly, risk assessment in conventional risk management solutions is not comprehensive. For example, risk is often not evaluated from a confidentiality-, integrity- and availability-perspective of information assets. With the emerging importance of data privacy and consumer protection laws across the globe, compliance is also important from a risk perspective, yet lacking in conventional risk management solutions. Static risk profile derived from point-in-time assessment used in conventional risk management solutions is inadequate. Finally, conventional risk management solutions may be cost prohibitive because it is often expensive to acquire and maintain governance, risk, and compliance (GRC) solution using a licensing model.

Accordingly, a need exists for a software as a service (SaaS) cyber risk management system (CMS) for providing continuous monitoring, notification, and updating of cyber risks associated with assets under management.

### BRIEF SUMMARY

According to one embodiment of the present invention, a method for continuous cyber risk management and monitoring is disclosed. The method includes storing, maintaining, and updating one or more rules that associates a cyber risk, threat, or vulnerability with an action for one or more assets. The one or more assets includes at least one of: information systems, critical infrastructure, tangible objects, persons, data, and metadata. When an event is detected, it is determined whether a rule applies to the event by searching and matching information associated with the event with the one or more rules. If a rule applies, an action is performed and various users are notified. The action performed includes a corrective, remedial, or mitigating action as specified by the applicable rule. The method for continuous cyber risk management and monitoring described herein is performed automatically and continuously.

A cyber risk management system (CMS) is also disclosed. The CMS includes a software as a service (SaaS) component located in the cloud and one or more tenants which communicate with the SaaS component via a client application and a communications network. The SaaS component of the CMS includes a Cloud Storage Data Layer, Cyber Risk Continuum Layer, Business Logic Layer, API Layer, and Front-End UI Layer.

### BRIEF DESCRIPTION OF THE SEVERAL VIEWS OF THE DRAWINGS

FIG. 1 is a diagram illustrating an overview of operation and components of the cyber risk management system, including a dark web scanner, according to one embodiment of the subject matter described herein.

FIG. 2 is a simplified block diagram of a system for a cyber risk management system (CMS) hosted in a Software as a Service (SaaS) model according to one embodiment of the subject matter described herein.

FIG. 3 illustrates a simplified block diagram for the Cloud Storage layer leveraged by the Core Services and Cyber risk Continuum layer and its components according to one embodiment of the subject matter described herein.

FIG. 4 illustrates a simplified block diagram of the Cyber risk Continuum layer and its components as part of the Cyber risk management system according to one embodiment of the subject matter described herein.

FIG. 5 illustrates a simplified block diagram of the business logic layer and its components as part of the Cyber risk management system according to one embodiment of the subject matter described herein.

FIG. 6 illustrates a simplified block diagram of the Core Services layer and its components as part of the Cyber risk management system according to one embodiment of the subject matter described herein.

FIG. 7 illustrates a flowchart diagram for a method for continuous cyber risk monitoring leveraging analytics engine provided by core services and push notification provided by the cyber risk Continuum Layer according to one embodiment of the subject matter described herein.

FIG. 8 illustrates a flowchart diagram for a method for continuous cyber risk monitoring leveraging the emerging cyber threats and vulnerabilities scanner and push notification provided by the cyber risk Continuum Layer according to one embodiment of the subject matter described herein.

FIG. 9 is a relationship diagram downing relationships between entities in the cyber risk management system according to one embodiment of the subject matter described herein.

### DETAILED DESCRIPTION

The present invention generally relates to systems and methods for assessing and managing cyber risks for all forms of assets through continuous cyber risk monitoring by leveraging a cyber risk continuum engine. The subject matter described herein includes storing, maintaining, and updating one or more rules that associates a cyber risk, threat, or vulnerability with an action for one or more assets. The one or more assets includes at least one of: information systems, critical infrastructure, tangible objects, persons, data, and metadata. When an event is detected, it is determined whether a rule applies to the event by searching and matching information associated with the event with the one or more rules. If a rule applies, an action may be performed and various users notified. The action performed includes a corrective, remedial, or mitigating action as specified by the applicable rule. The method for continuous cyber risk management and monitoring described herein is performed automatically and continuously. The cyber risk management described herein encompasses identification, analysis, evaluation, and treatment of risks through continuous monitoring of assets from a confidentiality, integrity, availability and compliance point of view.

Specific details are set forth in order to provide a thorough understanding of the embodiment. However, it is possible to a skilled cyber risk practitioner that the example embodiments may be practiced without some of these specific details. Further process flow and implementation details have not been described in detail, if already well known. Although the systems, processes, and flow diagrams have been described with reference to specific to features and functions, the invention defined herein the claims is not necessarily limited to the specific features or steps described. The specific features and steps are disclosed as preferred way of implementing the claimed invention.

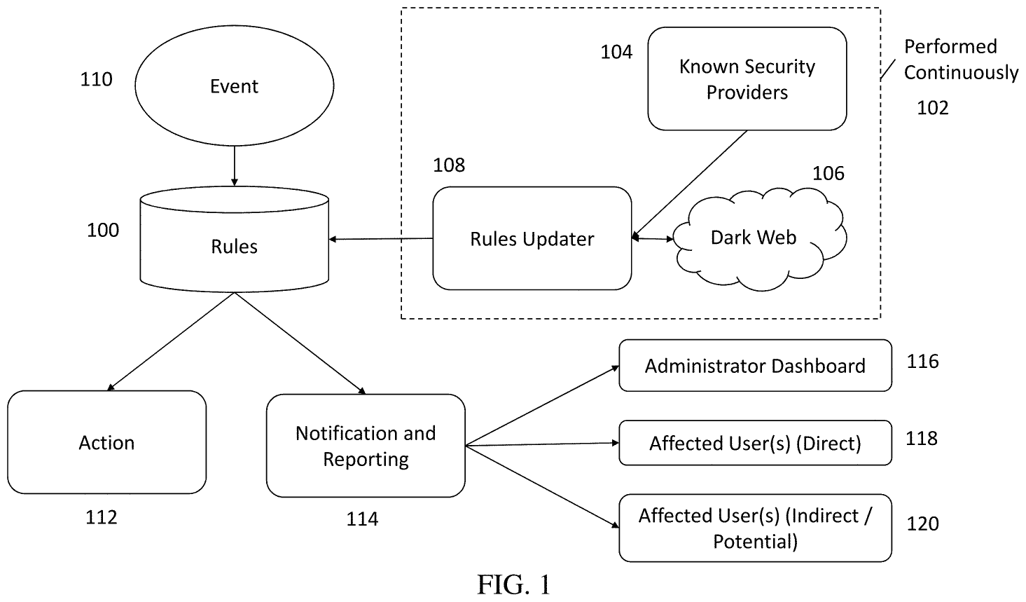

FIG. 1 is a diagram illustrating an overview of components and operation of a continuous cyber risk management system, including a dark web scanner, according to one embodiment of the subject matter described herein. With reference now to FIG. 1, an overview diagram of the cyber risk monitoring architecture is shown. A rules database and/or rules engine 100 may store and apply information associated with various cyber risk threats and vulnerabilities for one or more assets. The rules 100 may include separate and/or overlapping rules for different classes, categories, or levels of abstraction of the assets. For example, a rule may be associated with all email correspondence between a specific sender and recipient, while another rule may be associated with all internet traffic associated with a company or organization.

Rules 100 may be continuously or periodically updated 102 by rules update process 108. For example, known, reputable, or authorized security providers 104 may provide updated rules as security threats or vulnerabilities are discovered. Less well-known, less reputable, or unauthorized sources 106, such as those on the Dark Web, may be prevented from automatically or directly providing updated rules. Instead, the rules updater 108 may scan, search, or otherwise proactively process information obtained from these sources and generate and/or update the rules 100. The process of updating the rules 100 may be performed continuously in order to keep the system up-to-date.

Detection of an event 110 may trigger analysis of the event 110 to determine whether any rules 100 should be applied. Event 110 may be anything that affects an asset under management. For example, a port scan of a company's email server from a foreign source or a trojan horse virus executing from an employee's desktop computer. If a rule 100 exists that applies to the event 110, a corrective or mitigating action 112 may be taken. For example, action 112 may include deleting or quarantining a file.

Additionally, and potentially independently from whether an action 112 was taken, notification and reporting 114 may notify three categories of users regarding the cyber risk event. First, an administrator 116 may be alerted via a software user interface (UI), such as updating a dashboard. Second, any users 118 directly affected by the cyber risk event may be notified. For example, an email or text message may be sent to a user who accidentally opened a trojan horse email that their system may have been compromised and to contact designated information technology security personnel. Third, any users 120 potentially or indirectly affected by the cyber risk event may also be notified. For example, an email or text message may be sent to all other employees that an employee opened a trojan horse email and to remind them not to make the same mistake. As new events occur and/or are detected by the system, the continuously updated rules may be applied, users may be notified, and the assets under management may have their cyber risk managed. Additional details and examples will be described in greater detail below with respect to the remaining figures.

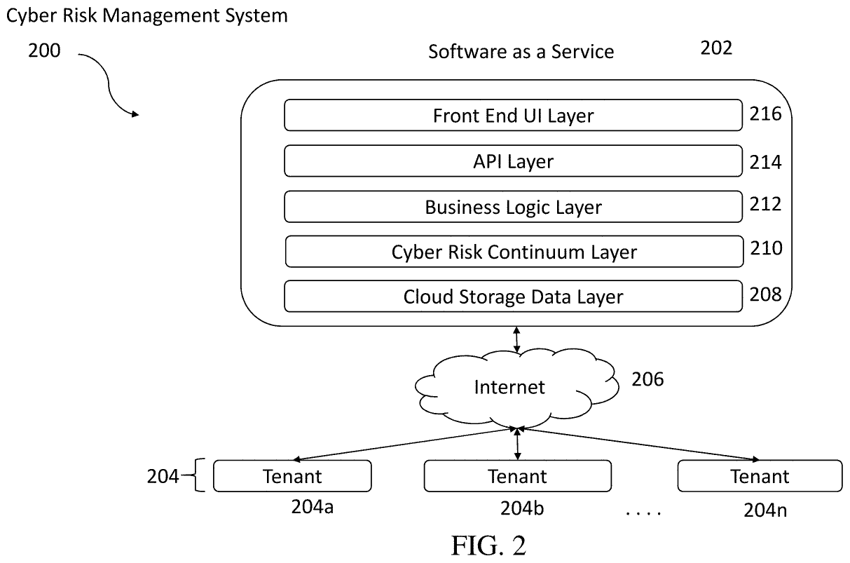

FIG. 2 is a simplified block diagram of a system for a cyber risk management system (CMS) hosted in a Software as a Service (SaaS) model according to one embodiment of the subject matter described herein.

SaaS is a software licensing and delivery model in which software is licensed on a subscription basis and is centrally hosted. SaaS is typically accessed by users using a thin client, e.g. via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance—including its data, configuration, user management, tenant individual functionality and non-functional properties.

The CMS 200 described herein may include both a SaaS component 202 and one or more tenants 204 which may communicate with the SaaS component 202 via a communications network, such as the Internet 206. The SaaS component 202 may be logically divided into one or more layers, each layer providing separate functionality and being capable of communicating with one or more other layers. The SaaS component 202 includes: Cloud Storage Data Layer 208, Cyber Risk Continuum Layer 210, Business Logic Layer 212, API Layer 214, and Front-End UI Layer 216.

Cloud Storage Data Layer 208 may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service application programming interface (API) or by applications that utilize the API, such as cloud desktop storage, a cloud storage gateway, or Web-based content management systems.

Cyber Risk Continuum Layer 210 may be composed of multiple components as identified herein as part reference architecture component model. Automated continuous risk monitoring is a paradigm shift from current approach to continuous risk monitoring which is predominantly a manual and static process.

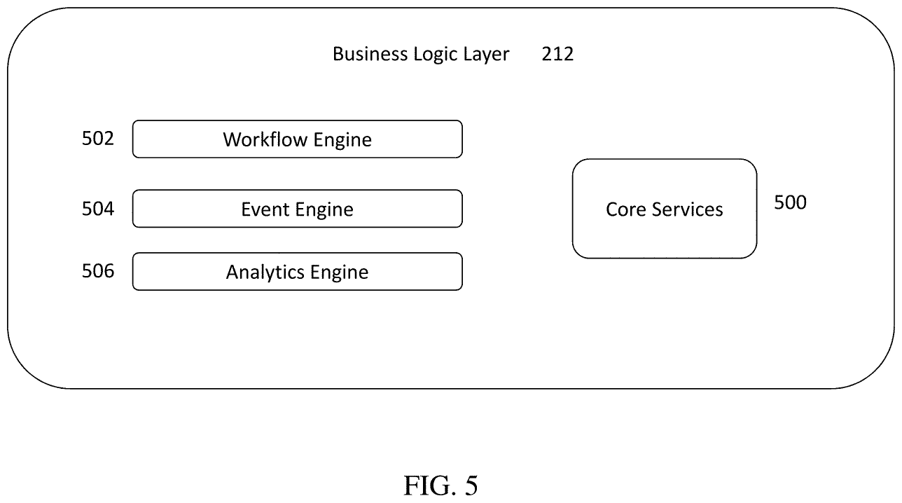

Business Logic Layer 212 sits between the cyber risk continuum layer 210 and the API layer 214. As will be described in greater detail with respect to FIG. 5, business logic layer 212 may include core services for tenant registration, risk assessment, dashboard etc. and for updating the knowledge base metadata for the analytics engine. Business logic layer 212 may also include a workflow engine for routing asset owner notifications as well as message handling between components. This may include Java Messaging Services or similar technologies for guaranteeing event processing in the SaaS platform between nodes for high availability.

API Layer 214 may include a combination of a representational state transfer (REST) API framework and JavaScript object notation (JSON). REST may include an architectural style of networked system and not be a standard itself, but may use other standards such as HTTP, URL, XML, etc. JSON may be an open standard format that uses human-readable text to transmit data objects consisting of attribute-value pairs. JSON may be used to transmit data between a server and web application, as an alternative to XML. Although originally derived from the JavaScript scripting language, JSON is a language-independent data format, and code for parsing and generating JSON data is readily available in a large variety of programming languages. API Layer 214 may be made up of core services and wrapper APIs for integration with cloud platform for key management services. This layer may be secured utilizing an API Gateway for client communications.

Front End UI Layer 216 may include an independent front-end web-based JavaScript framework that provides UI/UX capabilities. This may include intelligence for performing business logic and validation. Front End UI Layer 216 may communicates with the business logic layer 212 using RESTful Services API layer 214.

In contrast to the Front-End Layer 216, CMS 200 may also include a backend layer. The back-end layer may include multiple components such as a repository handler component, bulk loader component, and a billing/license management component. Core services and Cyber risk continuum layers 210 may interact with repository handlers for updating data across multiple repositories. These handlers are also responsible for any encryption/decryption of data as required. Customer can bulk load data into the system as part of initial setup. Finally, the billing/license management modules may be responsible for tracking license usage and billing.

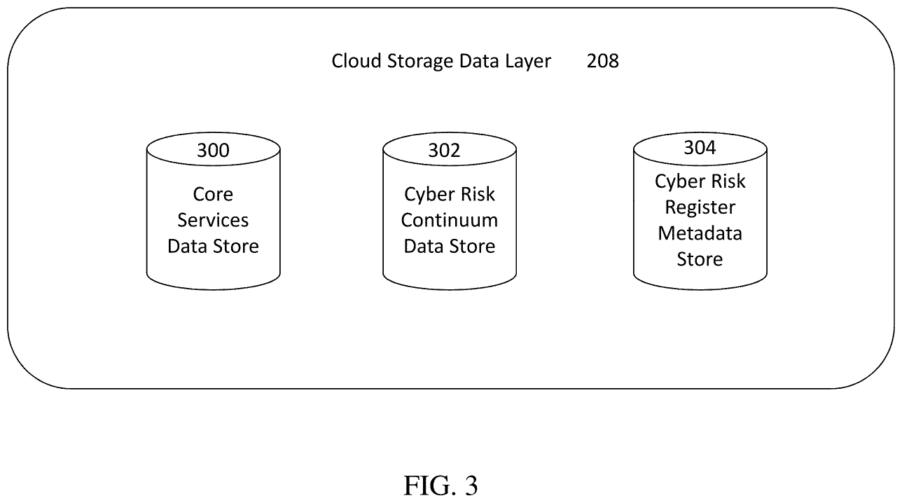

FIG. 3 illustrates a simplified block diagram for the Cloud Storage layer 208 leveraged by the Core Services and Cyber risk Continuum layer 210 and its components according to one embodiment of the subject matter described herein. Referring to FIG. 3, the cloud storage data layer 208 may include: a core services data store 300, a cyber risk continuum data store 302, and a cyber risk register metadata store 304. These data stores 300, 302, 304 may be stored and managed using a public or private cloud.

Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service application programming interface (API) or by applications that utilize the API, such as cloud desktop storage, a cloud storage gateway, or Web-based content management systems.

Metadata describes other data. It provides information about a certain item's content. For example, an image may include metadata that describes how large the picture is, the color depth, the image resolution, when the image was created, and other data. A text document's metadata may contain information about how long the document is, who the author is, when the document was written, and a short summary of the document. Web pages may include metadata in the form of meta tags. Description and keywords meta tags may be used to describe the data's content.

The core services data store 300 may store information used by core services 500.

The cyber risk continuum data store 302 may store information used by cyber risk continuum layer 210.

The cyber risk register metadata store 304 may store metadata describing information store in the cyber risk register 610. Metadata store 304 may also be used to provide analytics, recommendations, benchmarking, and other analysis of the metadata contained therein. For example, metadata store 304 may be used to provide industry specific recommendations. One of the analytics capabilities of CMS 200 may be to provide recommendations each step of the risk assessment process. In one example, as soon as an asset is defined with asset category and asset class, underlying analytics engine 506 may perform a query on the Cyber Risk Register Metadata store 304 pertaining to tenant-specific industry classification and/or subclassifications along with given asset category and class and may retrieve all available risks and related information. A risk assessor can then apply selectively threats, vulnerabilities, and related controls as applicable.

According to another aspect, metadata store 304 may be used to provide industry peer benchmark analysis. For example, at any given time, an asset owner or an assessor can perform an on-demand industry peer benchmarking through UI 216. In response, analytics engine 506 may query Cyber Risk Metadata Store 304 pertaining to tenant-specific industry classification and subclassifications along with given asset category and/or class and retrieve all available risks and related information and provide a gap analysis. The data may be visually presented on the dashboard where the asset owner can selectively assign any missing threat, vulnerability, or controls as applicable.

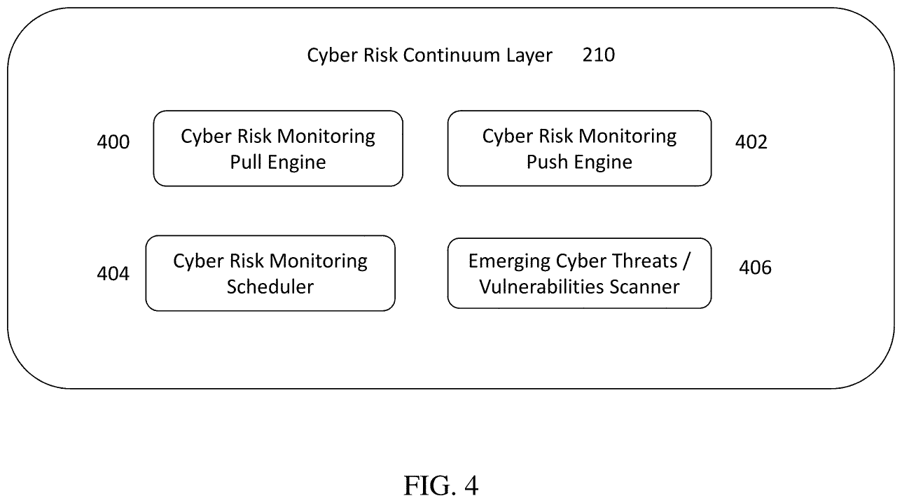

FIG. 4 illustrates a simplified block diagram of the Cyber risk Continuum layer 210 and its components as part of the Cyber risk management system 200 according to one embodiment of the subject matter described herein. Referring to FIG. 4, the Cyber risk Continuum layer 210 may include: a cyber risk monitoring pull engine 400, a cyber risk monitoring push engine 402, a cyber risk monitoring scheduler 404, and an emerging cyber threats/vulnerabilities scanner 406.

The cyber risk monitoring pull engine 400 may include an interface with US-CERT and NIST National Vulnerability Database and source known vulnerabilities pertaining to defined assets. The cyber risk monitoring pull engine 400 may analyze the threat impact and generate workflow ticket to the asset owner to evaluate the impact of vulnerability and provide controls to mitigate from emerging threat.

The cyber risk monitoring push engine 402 may Enable API interface for vulnerability and threat management systems to push notifications for impacted assets. The cyber risk monitoring push engine 402 may generate workflow ticket to the asset owner to evaluate the impact of vulnerability asset owners based to review impact and take corrective actions utilizing a pub/sub message queue.

The cyber risk monitoring scheduler 404 may perform a periodic risk assessment based on a predefined schedule.

The emerging cyber threats/vulnerabilities scanner 406 may perform proactive monitoring of dark web/deep web for emerging threats and vulnerabilities. The emerging cyber threats/vulnerabilities scanner 406 update knowledge base for analytics engine to review impact and notify asset owners for corrective actions.

FIG. 5 illustrates a simplified block diagram of the business logic layer 212 and its components as part of the Cyber risk management system 200 according to one embodiment of the subject matter described herein. Referring to FIG. 5, the business logic layer 212 may include: a workflow engine 502, an event engine 504, an analytics engine 506, and core services 508.

The workflow engine 502 used to route asset owner notifications and collaboration within the system.

The event engine 504 and/or the analytics engine 506 may be the trigger mechanism for internal notifications and message handling between the components. This will leverage Java Messaging Services for guaranteeing event processing in the SaaS platform between nodes for high availability.

The core services 500 may include a number of services and/or components that include, for example, tenant registration, risk assessment, CISO Dashboard etc. These services may also be responsible for updating the knowledge base metadata for the analytics engine.

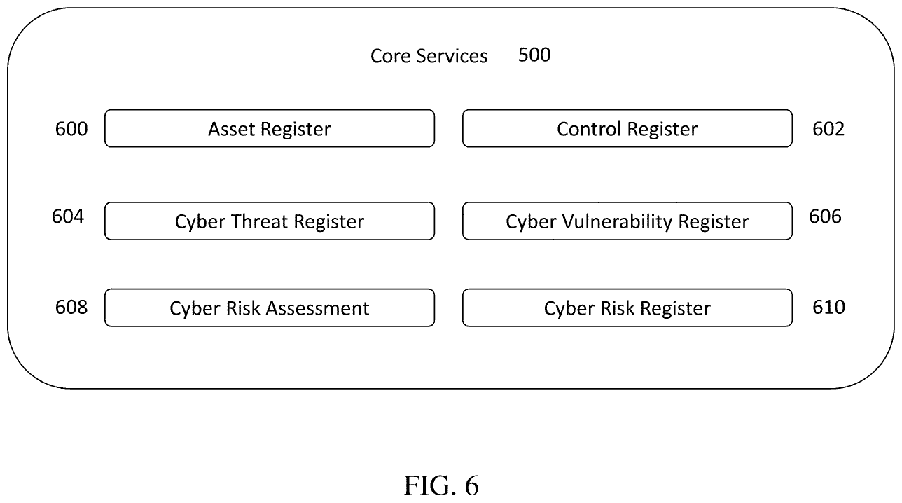

FIG. 6 illustrates a simplified block diagram of the Core Services layer 500 and its components as part of the Cyber risk management system 200 according to one embodiment of the subject matter described herein. Referring to FIG. 6, the Core Services layer 500 may include: asset register 600, controls register 602, cyber threat register 604, cyber vulnerability register 606, cyber risk assessment 608, and cyber risk register 610.

The asset register 600 may store information associated with one or more assets in a data structure, such as a table. Assets may be further associated with one or more categories and one or more classes. For example, an asset category table may store a tenant identifier (tenant_id) and an asset category identifier (asset_cat_id). The asset category identifier may include categories such as “data” or “person”. The asset class identifier (asset_class_id) may include classes such as “restricted” or “unrestricted”.

TABLE 1
Asset Register
Asset Register

| tenant_id | asset_id | asset_class_id | asset_cat_id | asset_owner |
|---|---|---|---|---|
| Provider-A | E0001 | restricted | data | bob |

Referring to Table 1, an exemplary asset register 600 entry is shown. For example, tenant_id “Provider-A” may be associated with asset_id “E0001,” asset_class “restricted,” asset_cat_id “data,” and asset_owner “bob”.

The control register 602 may store information associated with one or more controls to mitigate risks in a data structure, such as a table. For example, a part of a risk assessment process, a control assessment may be performed. One or more controls may then be assigned to mitigate identified risks. A control score is against the risk score which is calculated as the result of likelihood multiplied by the consequence. A risk assessor can add one or more controls per risk_id which the assessor may determine subjectively based on the outcome of the control assessment and the effectiveness of control to mitigate perceived risk. Upon assignment, the control register and risk register may be updated with the control_id for every risk_id.

TABLE 2
Control Register
Control Register

| tenant_id | asset_id | risk_id | control_id | control_score |
|---|---|---|---|---|
| Provider-A | E0001 | R001 | C001 | 30 |
| | | | (Deployment of | |
| | | | API Gateway) | |
| | | R001 | C002 | 30 |
| | | | (Application Vulnerability | |
| | | | Scanners) | |
| | | R001 | C003 | 30 |
| | | | (Penetration testing) | |
| | | R002 | C004 | 60 |
| | | | (API Key Management) | |
| | | R002 | C005 | 20 |
| | | | (Enforce API Key | |
| | | | Restrictions) | |

Referring to Table 2, an exemplary control register 602 entry is shown. For example, control register 602 may include a tenant_id, asset_id, risk_id, control_id, and control_score. The tenant_id identifies a user or group of users who share a common access with specific privileges to the software instance of the SaaS component 202 of the CMS 200. Asset_id identifies a person, digital file, etc. that is under risk management. Risk_id identifies a unique entry in the cyber vulnerability register 606. Here, two risk_ids are shown (R001 and R002) each associated with multiple control_ids and control_scores. For example, risk_id R001 may be associated with control_ids C001 and C002 corresponding to deployment of an API gateway and application vulnerability scanners, respectively. Similarly, risk_id R002 may be associated with control_ids C003, C003, and C004 corresponding to penetration testing, API key management, and enforcing API key restrictions, respectively. For each combination of risk_id and control_id, there may be a control_score (e.g., range between 0-100). Here, a control_score of 30 may be assigned for control_ids C001, C002, and C003. A control_score of 60 may be assigned for control_id C004. And finally, a control_score of 20 may be assigned for control_id C005.

The cyber threat register 604 may store information associated with cyber threats in a data structure, such as a table. For example, cyber threat register 604 may store a tenant_id, an asset_id, a threat_id, and a likelihood_score. The tenant_id identifies a user or group of users who share a common access with specific privileges to the software instance of the SaaS component 202 of the CMS 200. Asset_id identifies a person, digital file, etc. that is monitored for cyber threat. Threat_id identifies one of a plurality of possible threats for which an action may be taken or asset owners may be notified. Likelihood_score may be a numerical value or other indicator of a threat likelihood between a range from little or no threat to high or maximum threat.

TABLE 3
Cyber Threat Register
Cyber Threat Register

| tenant_id | asset_id | threat_id | likelyhood_score |
|---|---|---|---|
| Provider-A | E0001 | T0001 | High(1.0) |
| | | (Insecure | |
| | | API) | |

Referring to Table 3, an exemplary cyber threat register 604 entry is shown. A risk assessor may initiate a risk assessment process for provider-A. The risk assessor may assign a threat “Insecure API” with a thread ID=T0001” to the asset “asset_id=E0001” and provides likelihood score of “high” in the threat register 604. All threats may be predefined in the CMS 200 with its own unique taxonomy to maintain consistency.

TABLE 4
Threat Likelihood
Threat Likelihood

| Vulnerability | | Low (0.01) | Medium (0.05) | High (1.0) |
|---|---|---|---|---|
| Impact | Low (10) | Low Risk | Low Risk | Low Risk |
| | | (10 × 0.1 = | (10 × 0.1 = 1.0) | (10 × 0.1 = |
| | | 1.0) | | 1.0) |
| | Medium | Low Risk | Medium Risk | Medium Risk |
| | (50) | (50 × 0.1 = | (50 × 0.5 = 25.0) | (50 × 1.0 = |
| | | 5.0) | | 50.0) |
| | High (100) | Low Risk | Medium Risk | Medium Risk |
| | | (100 × 0.1 = | (50 × 1.0 = 50.0) | (100 × 1.0 = |
| | | 10.0) | | 100.0) |

Referring to Table 4, exemplary threat likelihood entries are shown. For example, to measure risk, a simple low, medium, high scale is used to determine the probability of likelihood and the magnitude of consequence. The determination of these risk levels or ratings may be subjective. High Risk (50 to 100) may indicate a strong need for corrective measures. An existing system may continue to operate, but a corrective action plan must be put in place as soon as possible. Medium Risk (10 to 50) may indicate that corrective actions are needed and a plan must be developed to incorporate these actions within a reasonable period of time as agreed by the asset owner. Low Risk (0 to 10) may indicate that the asset owner should determine whether additional compensating controls are needed or to accept the risk.

The cyber vulnerability register 606 may store information associated with cyber vulnerabilities in a data structure, such as a table. For example, a risk assessor can add one or more vulnerabilities to a threat and qualitatively determine the consequences with a high, medium or low score. For example, a risk assessor may assign a vulnerabilities to an identified threat and the system may automatically calculate a risk score based on selected risk calculation method. A risk_id may also be assigned to every combination of threat and vulnerability.

TABLE 5
Cyber Vulnerability Register
Cyber Vulnerability Register

| tenant_id | asset_id | threat_id | likelyhood_score | vuln_id | impact_score | risk_score | risk_id |
|---|---|---|---|---|---|---|---|
| Provider- | E0001 | T0001 | High (1.0) | V0001 | High | 100 | R001 |
| A | | (Insecure | | (inadequate | (100) | | |
| | | API) | | SW testing) | | | |
| | | T0001 | High (1.0) | V0002 | High | 100 | R002 |
| | | (Insecure | | (inadequate | (100) | | |
| | | API) | | protection of | | | |
| | | | | API keys) | | | |

Referring to Table 5, an exemplary cyber vulnerability register 606 entry is shown. In this example, the same threats (insecure API T0001) which have the same likelihood score (high 1.0) may be associated with separate vulnerabilities. This is indicated by separate rows—one for vulnerability identifier V0001 (inadequate software testing) and a second for vulnerability identifier V0002 (inadequate protection of API keys). Each of these vulnerabilities may be the same impact score (high 100) and risk score (100) but may be separately identified by risk identifiers R001 and R002.

The cyber risk assessment 608 may store the results of any risk assessments.

The cyber risk register 610 may store information associated with cyber risks in a data structure, such as a table.

TABLE 6
Cyber Risk Register
Cyber Risk Register

| tenant_id | asset_id | risk_id | risk_score | control_score |
|---|---|---|---|---|
| Provider-A | E0001 | R001 | 100 | 90 |
| | | R002 | 100 | 80 |

Referring to Table 6, an exemplary cyber risk register 610 entry is shown. In this example, provider-A and asset E0001 are associated with two different risks. First, as indicated by risk_id R0001, may have a risk_score of 100 and a control_score of 90. Second, as indicated by risk_id R0002, may have a risk_score of 100 yet a control_score of 80. This may indicate a difference in the ability to manage or mitigate the different risks, even though both risks have the same risk score.

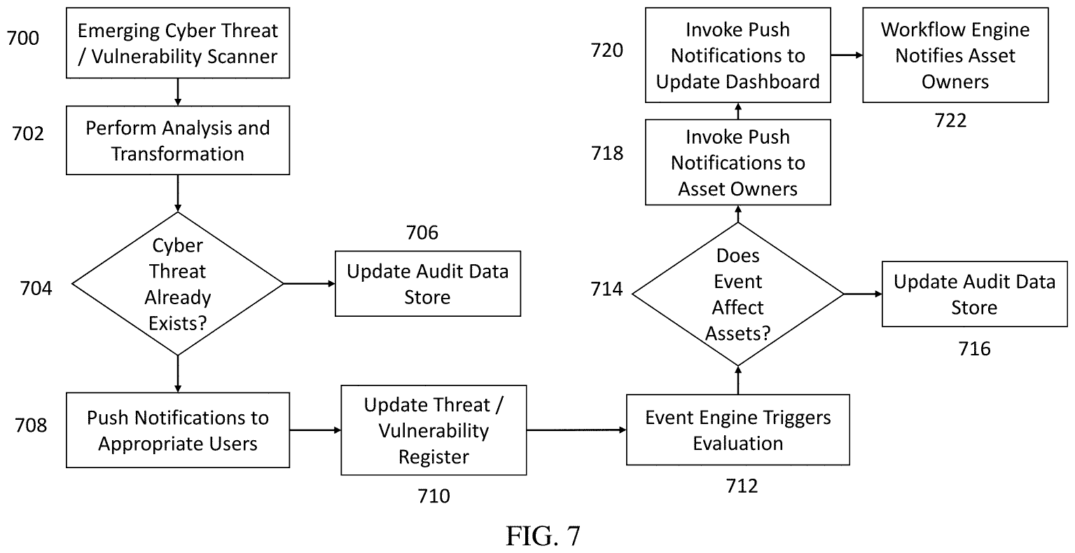

FIG. 7 illustrates a flowchart diagram for a method for continuous cyber risk monitoring leveraging analytics engine provided by core services and push notification provided by the cyber risk Continuum Layer according to one embodiment of the subject matter described herein.

Referring to FIG. 7, Cyber risk Continuum Layer 210 incorporates scheduler 404 which invokes the emerging threats and vulnerabilities scanner 406 periodically at predefined schedules and scans dark web and other sources for emerging threats and vulnerabilities. It also utilizes the cyber risk monitoring pull engine 400 to pull emerging threats and vulnerabilities from other aggregators, both commercial and noncommercial of such information.

At step 700, raw information obtained from the emerging cyber threat and vulnerability scanner is transformed utilizing the business logic layer and mapped to system specific taxonomy for further analysis.

At step 702, the business logic layer invokes the analytic engine to analyze the transformed threats and vulnerabilities and evaluates if such threat and vulnerability already exists in the cyber threat register and cyber vulnerability register respectively.

At step 704, it is determined whether the cyber threat or vulnerability already exists. This may be accomplished by, for example, searching for matching data or metadata in one of the stores in the cloud storage data layer.

At step 706, if either the threat or vulnerability already exists, the business logic layer updates the audit data store.

At step 708, if either the threat or vulnerability does not exist, a push notification is sent to appropriate users and, at step 710, the cyber threat register and/or the cyber vulnerability register is updated.

At step 712, the event engine, as part of business logic layer, triggers an evaluation procedure by invoking the analytics engine to evaluate the impact of the newly emerged cyber threat and/or the cyber vulnerability with respect to specific tenant assets.

At step 714, it is determined whether the event affects assets under cyber risk management.

At step 716, if no assets are affected by the newly emerged cyber threat and/or the cyber vulnerability, the audit data store may be updated.

At step 718, however, if at least one asset is affected by the newly emerged cyber threat and/or the cyber vulnerability, the push notification engine may be invoked to provide push notifications to asset owners.

At step 720, to event engine updates any pull notification subscribers as well as the chief information security officer (CISO) and/or the asset owner dashboard, which is part of a front-end UI.

At step 722, the workflow engine creates a work item for asset owner under the tenant context to create a new risk in the cyber risk register and create a risk treatment plan or apply countermeasures.

In one exemplary scenario for providing continuous monitoring, notification, and updating of cyber risks associated with assets under management, a tenant, such as a healthcare provider “provider-A”, may begin by being be onboarded into CMS 200. During the onboarding process, a tenant business category identifier for “Health Insurance” may be updated in a database of tenant information for Provider-A. As a result, an asset register may be created for provider-A which includes an asset class and an asset category. Assets are identified with a unique asset ID and stored in the asset database. Provider-A then creates an asset in the asset register for Electronic Protected Health Information.

In addition to being automatically triggered, risk assessments may also be triggered manually when a risk assessor initiates a risk assessment process. For example, a risk assessor may initiate a simple qualitative HIPAA risk assessment process for provider-A. Risk assessor may assign a first threat identifier to the asset and provide likelihood score of “high” in the threat register. All threats may be predefined in the CMS with their own unique taxonomy to maintain consistency in the system.

Upon update of the threat register, the event engine may trigger an event 110. Based on incoming event 110, the analytics engine may perform a lookup in the cyber risk continuum data store using the combination of business category, asset category, and threat identifier. If the threat identifier already exists for the Health Insurance category and for the asset category, no further action 112 is taken. If the data doesn't exist, the action 112 taken may include that the analytics engine updates the data store.

Next, notification and reporting 114 may be activated to update an administrator dashboard for the asset owners, directly affected user, and anyone else monitoring the asset status. For example, a cyber risk monitoring push engine may perform a join query across the asset table, tenant table, and threat register to filter for assets for a desired asset category and tenant's business category identifier where newly added threat identifier doesn't exist. If records are found, the push engine may update the threat register for the assets for similar tenants from the query result and create a work item for the asset owners to accept or reject the newly added threat. The event engine may then update dashboard 116 for the asset owners and anyone else monitoring the asset status 120.

Next in the risk assessment process may be to evaluate consequences of threat compromising vulnerabilities. The risk assessor can add one or more vulnerabilities to a threat and qualitatively determine the consequences with a high, medium or low score. The risk assessor may assign vulnerabilities to the identified threat and the system may calculate the risk score based on selected risk calculation method. A risk identifier may be assigned to every combination of threat and vulnerability. The system may also update the risk register.

Upon update of vulnerability register, the event engine may trigger an event. Based on the triggered incoming event, the analytics engine 506 may perform a lookup in the cyber risk continuum data store 302 with the combination of business category, asset category, threat_id and vuln_id. If the record already exists for the Health Insurance category and for the asset category, no further action is taken. If the data doesn't exist, analytics engine 506 updates the data store and the cyber risk register metadata store 304.

Cyber risk monitoring push engine 402 may perform a join query across asset table, tenant table and vulnerability register to filter for assets with asset category and tenant's biz category where newly added vulnerability doesn't exist.

If records are found, the push engine 402 updates the vulnerability register 606 for the assets for similar tenants from the query result and creates a work item for the asset owners to accept or reject the newly added vulnerability. The event engine 504 picks up on the event and updates dashboard for the asset owners and anyone else monitoring the asset status.

Next in the risk assessment process may be to perform a control assessment and assign one or more controls to mitigate identified risks. A control score is compared against the risk score which is calculated as the result of likelihood multiplied by the consequence.

The risk assessor can add one or more controls per risk identifier, which the assessor may determine subjectively based on the outcome of control assessment and the effectiveness of control to mitigate perceived risk. Upon assignment, the control register 602 and risk register 610 is updated with the control identifier for every risk identifier.

At the end of the risk assessment process, the asset “E0001” may be left with a residual risks. As part of risk management strategy, the asset owner may wish to implement additional controls to bring the risks to an acceptable level or can look at other alternatives such as transfer risk or accept risk.

For example, upon update of risk register 610, the event engine 504 may trigger an event. Based on the triggered incoming event, the analytics engine 506 may perform a lookup in the cyber risk continuum data store 302 with the combination of biz_cat_id, asset_cat, threat_id, vuln_id and control_id. If the record already exists for the Health Insurance category and for the asset category, no further action is taken. If the data doesn't exist, analytics engine 506 may update the data store 302 and the cyber risk register meta-data store 304.

Cyber risk monitoring push engine 402 may perform a join query across asset table 600, tenant table, and vulnerability register 606 to filter for assets with asset category and tenant's biz_cat_id where newly added control doesn't exist.

If records are found, the push engine may update the control register 602 for the assets for similar tenants from the query result and may create a work item for the asset owners to accept or reject the newly added control. The event engine 504 may pick up on the event and update dashboard for the asset owners and anyone else monitoring the asset status.

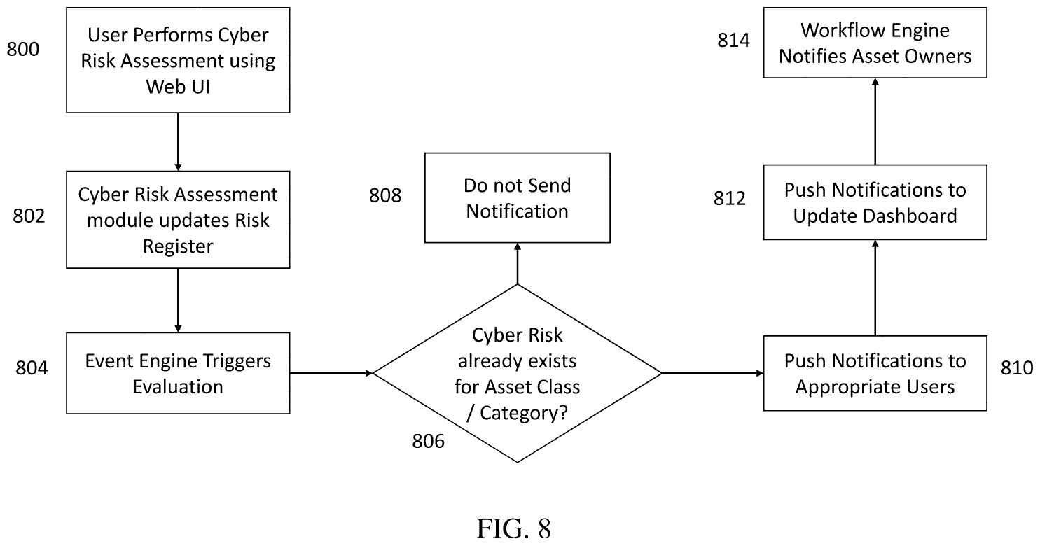

FIG. 8 illustrates a flowchart diagram for a method for continuous cyber risk monitoring leveraging the emerging cyber threats and vulnerabilities scanner and push notification provided by the cyber risk Continuum Layer according to one embodiment of the subject matter described herein.

Referring to FIG. 8, at step 800, tenants perform cyber risk assessment by utilizing the web UI layer. The communication between the web UI and the business logic layer is performed via the API layer.

At step 802, outcome of the cyber risk assessment is captured in a cyber risk register pertaining to the tenant and stored as a metadata in the cyber risk metadata store pertaining to tenant specific industry classification and sub classifications.

At step 804, after a tenant performs cyber risk assessment and updates the cyber risk register, the event engine 504 invokes analytics engine 506 to evaluate, at step 806, whether the cyber risk already exists in the other tenant's cyber risk register 610.

At step 808, if the cyber risk exists in the cyber risk register 610, no further action is taken for the tenant.

At step 810, however, if the cyber risk does not exist in the cyber risk register 610, push notification engine 402 is activated.

At step 812, subscribers to event engine 504 updates the CISO/Asset Owner dashboard, which is part of front-end UI.

At step 814, the workflow engine 502 creates a work item for asset owner under the tenant context to review the cyber risk and related threat and vulnerability combination for a possible risk treatment plan.

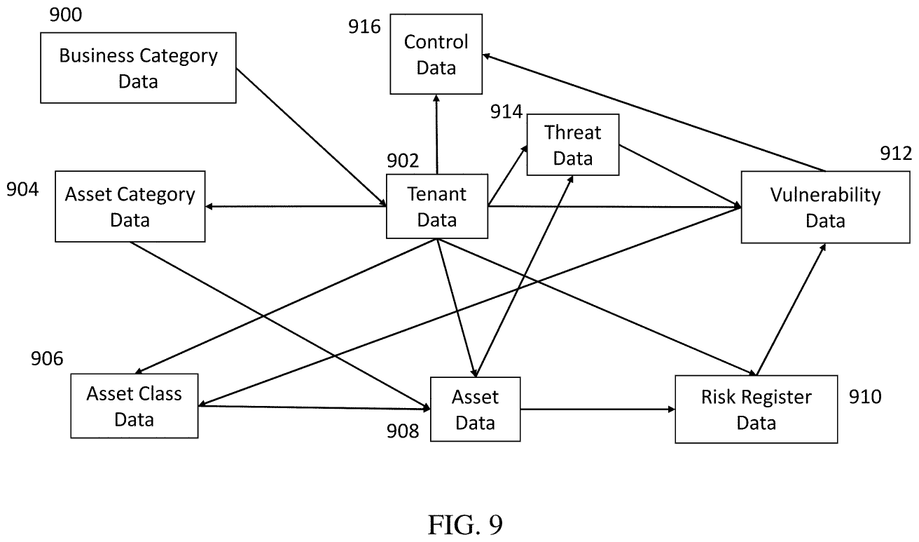

FIG. 9 is a relationship diagram showing relationships between entities in the cyber risk management system according to one embodiment of the subject matter described herein. Referring to FIG. 9, business category data 900 may be related to tenant data 902. For example, business category identifier may be fed into tenant data table 902 and associated with a tenant identifier.

Tenant data 902 may be related to every other data structure. For example, tenant data 902 may be fed into asset category data 904 to be associated with an asset category identifier. Tenant data 902 may also be fed into asset class data 906 to be associated with an asset class identifier. Tenant data 902 may also be fed into asset data 908 to be associated with an asset identifier (in addition the asset class id and asset category id). Tenant data 902 may also be fed into risk register data 910 to be associated with a risk identifier, a risk score, and a control score. Tenant data 902 may also be fed into vulnerability data 912 to be associated with vulnerability identifier (in addition to a threat id, impact score, and asset id). Tenant data 902 may also be fed into threat data 914 to be associated with threat identifier and likelihood score (in addition to an asset id). Finally, tenant data 902 may be fed into control data 916 to be associated with a control identifier (in addition to the asset id, risk id, and control id).

In addition to receiving data from tenant data 902, asset category data 904 may send data to asset data 908. Similarly, asset class data 906 may send data to asset data 908. Asset class data 906, however, also receives data from vulnerability data 912.

In addition to receiving data from tenant data 902, asset category 904 and asset class 906, asset data 808 may send data to threat data 914.

In addition to receiving data from tenant data 902, risk register data 910 may receive data from asset data 908 and may send data to vulnerability data 912.

In addition to receiving data from tenant data 902 and risk register data 910, vulnerability data 912 may receive data from threats data 914 and may send data to control data 916.

In addition to receiving data from tenant data 902, control data may also receive data from vulnerability data 912.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-35. (canceled)

36. A method for continuous cyber risk management and monitoring comprising:
updating one or more rules that associate a cyber risk, threat, or vulnerability with an action for one or more assets,
wherein the one or more assets includes at least one of: information systems, critical infrastructure, tangible objects, persons, data, and metadata;
detecting an event affecting an asset of the one or more assets;
determining whether a rule applies to the event by searching and matching the one or more rules with information associated with the event; and
when a rule applies:
performing an action, wherein performing an action includes performing at least one of a corrective, remedial, or mitigating action as specified by the applicable rule; and
notifying users,
wherein the method is performed automatically and continuously.

37. The method of claim 36, wherein updating the one or more rules includes receiving emerging threats and vulnerabilities from a commercial or a noncommercial aggregator of rules information.

38. The method of claim 36, wherein updating the one or more rules includes scanning the dark web and other sources for emerging threats and vulnerabilities.

39. The method of claim 38, wherein scanning the dark web is performed periodically based on a predefined schedule.

40. The method of claim 36, wherein the method is performed using a software as a service (SaaS) model wherein computer-executable instructions are stored and executed using a combination of a cloud service and a thin client installed at one or more tenants of the cloud service.

41. The method of claim 40, wherein tenants are classified and subclassified by industries they represent.

42. The method of claim 36, wherein the one or more rules associates attributes and properties with each asset, wherein the attributes and properties include at least one of an: asset classification, asset category, sub-category, and asset owner.

43. The method of claim 36, wherein notifying users includes at least one of: notifying users of assets similar to the assets directly affected by the event and notifying asset owners.

44. The method of claim 36, wherein notifying users includes at least one of:
updating an administrator dashboard,
sending push notifications including at least one of: an email, a text message, and a voicemail message, and
providing pull notifications including at least one of: posting on a website and updating a display on a dashboard user interface.

45. A system for continuous cyber risk management and monitoring comprising:
a software as a service (SaaS) component for automatically and continuously performing cyber risk management and monitoring, wherein the SaaS component includes:
a cloud storage data layer for storing one or more rules that associates a cyber risk, threat, or vulnerability with an action for one or more assets, wherein the one or more assets includes at least one of: information systems, critical infrastructure, tangible objects, persons, data, and metadata;
a cyber risk continuum layer for determining whether a rule applies and, if so, at least one of performing an action and notifying users, wherein performing an action includes performing a corrective, remedial, or mitigating action as specified by the applicable rule;
a business logic layer for detecting an event and determining whether a rule applies to the event by searching and matching information associated with the event with the one or more rules;
an application programming interface (API) layer for communicating between the business logic layer and a front-end UI layer;
the front-end UI layer for communicating and displaying information between the API layer and a client application executing on one or more tenants of the SaaS component.

46. The system of claim 45, wherein updating the one or more rules includes receiving emerging threats and vulnerabilities from a commercial or a noncommercial aggregator of rules information.

47. The system of claim 45, wherein updating the one or more rules includes scanning the dark web and other sources for emerging threats and vulnerabilities.

48. The system of claim 47, wherein scanning the dark web is performed periodically based on a predefined schedule.

49. The system of claim 45, wherein the method is performed using a software as a service (SaaS) model wherein computer-executable instructions are stored and executed using a combination of a cloud service and a thin client installed at one or more tenants of the cloud service.

50. The system of claim 49, wherein tenants are classified and subclassified by industries they represent.

51. The system of claim 45, wherein determining whether a rule applies to the event is manually initiated by a tenant utilizing a web user interface (UI) layer.

52. The system of claim 45, wherein the one or more rules associates attributes and properties with each asset, wherein the attributes and properties include at least one of an: asset classification, asset category, sub-category, and asset owner.

53. The system of claim 45, wherein notifying users includes at least one of: notifying users of assets similar to the assets directly affected by the event, and notifying asset owners.

54. The system of claim 45, wherein notifying users includes at least one of:
updating an administrator dashboard,
sending push notifications including at least one of: an email, a text message, and a voicemail message, and
providing pull notifications including at least one of: posting on a website and updating a display on a dashboard user interface.

55. A computer program product for continuous cyber risk management and monitoring, said computer program product comprising:
a computer readable storage medium having computer readable program code embodied therewith, the computer readable program code comprising computer readable program code configured for:
updating one or more rules that associate a cyber risk, threat, or vulnerability with an action for one or more assets,
wherein the one or more assets includes at least one of: information systems, critical infrastructure, tangible objects, persons, data, and metadata;
detecting an event affecting an asset of the one or more assets;
determining whether a rule applies to the event by searching and matching the one or more rules with information associated with the event; and
when a rule applies:
performing an action, wherein performing an action includes performing at least one of a corrective, remedial, or mitigating action as specified by the applicable rule; and
notifying users,
wherein the method is performed automatically and continuously.
